(19) United States
(12) Patent Application Publication
(10) Pub. No.: US 2010/0110038 A1
(43) Pub. Date: May 6, 2010

(54) MUTUAL CAPACITANCE TOUCH SCREEN AND COMBINED MUTUAL CAPACITANCE TOUCH SCREEN

(76) Inventors: Michael Mo, Shenzhen (CN); JK Zhang, Shenzhen (CN)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/605,581

(22) Filed: Oct. 26, 2009

(30) Foreign Application Priority Data
Oct. 31, 2008 (CN) 200810171009.3

(51) Int. Cl. G06F 3/044

(52) U.S. Cl. 345/174

(57) ABSTRACT

A mutual capacitance touch screen and a combined mutual capacitance touch screen formed by the combination of mutual capacitance touch screens. A driving layer and a sensor layer are included, wherein the driving layer comprises driving electrodes distributed at intervals in the same plane; the sensor layer comprises sense electrodes distributed at intervals in the same plane; and the places where the sense electrodes are distributed in the sensor layer are just over against the intervals between the driving electrodes in the driving layer so that the driving electrodes and the sense electrodes together fill the touch area of the touch screen. The driving electrodes are not over against the sense electrodes in terms of space positions to increase the proportion of capacitance C_{T} to mutual capacitance C, wherein the capacitance C_{T} is formed between the driving electrodes and the top of the sense electrodes; consequently, the effective capacitivity of the mutual capacitance touch screen is effectively increased.

### TECHNICAL FIELD

The present invention relates to a touch induction input device, particularly to a touch input device which uses mutual capacitance as an inductor.

### BACKGROUND ART

The touch screen is a touch sense input device which is widely used at present. According to the principle of touch induction, touch screens in the prior art comprise resistance touch screens, capacitance touch screens, surface infrared touch screens, etc., wherein the resistance touch screens are popular for many years because of the advantages of low cost, easy realization, simple control, etc. Recently, the capacitance touch screens are well received by the public because of the advantages of high light transmittance, abrasion resistance, ambient temperature change resistance, ambient humidity change resistance, long service life and the complicated high-grade functions for realizing multipoint touch, etc.

Using capacitance change as the induction principle exists for a long time. In order to make the touch screen effectively work, a transparent capacitance sensor array is needed. When a human body or a special touch device such as a handwriting pen approaches to an induction electrode of a capacitor, the capacitance value detected by a sense control circuit can be changed. According to the distribution of capacitance values change in a touch area, the touch condition of the human body or the special touch device in the touch area can be judged. According to capacitance forming modes, the touch screens in the prior art comprise self capacitance touch screens and mutual capacitance touch screens, wherein the self capacitance touch screens use sense electrodes and alternate current grounds or direct current level electrodes to form the change of the capacitance value as a signal of touch sense, the mutual capacitance touch screens use the change of the capacitance value formed between two electrodes as the signal of touch sense, and sometimes, mutual capacitance is also called projection capacitance.

As shown in FIG. 11, the mutual capacitance touch screen in the prior art comprises a touch plane 100′, driving wires 210′ and sense wires 310′ which are not in the same plane, and a medium plane 910′ held between the driving wires 210′ and the sense wires 310′. As shown in FIGS. 11-1 and 11-2, the driving wires 210′ are parallel mutually, the sense wires 310′ are parallel mutually, and the driving wires 210′ and the sense wires 310′ crossed orthogonally in space. The driving wires 210′ are electrically connected with excitation signals, the sense wires 310′ are electrically connected with the sense control circuit so as to form mutual capacitance between the driving wires 210′ and the sense wires 310′, and mutual capacitance C formed at the crossing points of the driving wires 210′ and the sense wires 310′ is a main capacitance data signal detected by the sense control circuit. As shown in FIG. 11-3, mutual capacitance C comprises capacitance C_{B} between the driving wires 210′ and the bottom of the sense wires 310′ and capacitance C_{T} between the driving wires 210′ and the top of the sense wires 310′, namely C=C_{B}+C_{T}. As shown in FIG. 11-4, when a finger 150′ comes into contact with the touch plane 100′ in the touch area, the finger 150′ is equivalent to an electrode above the sense wires 310′, which changes the electric field between the driving wires 210′ and the top of the sense wires 310′. The change can be regarded as that the finger 150′ sucks electric field lines between the driving wires 210′ and the top of the sense wires 310′ so that C_{T} changes, which results in the change of mutual capacitance C. The sense control circuit detects the change condition of mutual capacitance C in the whole touch area of the touch plane 100′ to determine the position and strength of the touched point in the touch area. By reasonable design of the sense control circuit, the sense control circuit can simultaneously detect the distribution situation of multipoint touch on the touch plane 100′ and realize the function of multipoint sense touch. The proportion of the change range of the C_{T} value to mutual capacitance C when touch does not happen is called effective capacitivity.

As shown in FIG. 11, when the touch screen in the prior art is touched, capacitance C_{B} between the driving wires 210′ and the bottom of the sense wires 310′ is not influenced because of touch. Because the bottom of the sense wires 310′ is just over against the driving wires 210′, the proportion of capacitance C_{B} to mutual capacitance C is larger, so the effective capacitivity is lower. Generally, the effective capacitivity of the mutual inductance touch screen in the prior art is only about 30%, which makes the signal-to-noise ratio of the touch screen lower, so the complicated sense control circuit is designed to accurately judge the touch condition of the human body or the special touch device to the touch screen, and the design and manufacturing cost of the touch screen is increased.

### Invention Contents

The technical problem the present invention aims to settle is to avoid the defects of the prior art to provide a mutual capacitance touch screen and a combined mutual capacitance touch screen which can greatly increase the effective capacitivity.

The present invention solves the technical problem by adopting the following technical schemes:

A mutual capacitance touch screen is designed and manufactured. The mutual capacitance touch screen comprises a touch plane made of a transparent insulating medium, a driving layer and a sensor layer which are covered with the touch plane, and a capacitance medium plane which is made of a transparent insulating medium and is held between the driving layer and the sensor layer. Especially, the driving layer comprises plate driving electrodes which are made of transparent conductive materials and distributed at intervals in the same plane; the sensor layer comprises plate sense electrodes which are made of transparent conductive materials and distributed at intervals in the same plane; and the places where the sense electrodes are distributed in the sensor layer are just over against the intervals between the driving electrodes in the driving layer so that the driving electrodes and the sense electrodes together fill the touch area of the touch plane. The driving electrodes are electrically connected with peripheral excitation signal modules of the touch screen, and the sense electrodes are electrically connected with peripheral sense control modules of the touch screen.

In order to further increase the effective capacitivity, the touch screen also comprises a shielding layer which is arranged above or below the lower one of the driving layer and the sensor layer or is embedded in the lower layer. The shielding layer comprises plate shielding electrodes made of transparent conductive materials and shielding electrode lead-out wires, the shielding electrodes are just over against the areas occupied by the electrodes in the higher one of the driving layer and the sensor layer, the shielding electrodes electrically hang, or all shielding electrodes are earthed or electrically connected with the peripheral direct current sources of the touch screen by the shielding electrode lead-out wires.

In order to further increase the effective capacitivity, the touch screen also comprises a dummy electrode layer which is arranged above or below the higher one of the driving layer and the sensor layer or is embedded in the higher layer. The dummy electrode layer comprises plate dummy electrodes made of transparent conductive materials, wherein the dummy electrodes are just over against the areas occupied by the electrodes of the lower one of the driving layer and the sensor layer.

The mutual capacitance touch screen also comprises driving electrode connecting wires and sense electrode connecting wires which are made of transparent conductive materials, and driving electrode lead-out wires and sense electrode lead-out wires. The driving electrodes are grouped and connected in series through the driving electrode connecting wires, and the position relation between the driving electrode connecting wires in the driving layer comprises collinearity and parallelism. The sense electrodes are grouped and connected in series through the sense electrode connecting wires, the position relation between the sense electrode connecting wires in the sensor layer comprises collinearity and parallelism, and the driving electrode connecting wires are perpendicular to the sense electrode connecting wires. Each driving electrode group is electrically connected with peripheral excitation signal modules of the touch screen by the driving electrode lead-out wires, and each sense electrode group is electrically connected with peripheral sense control modules of the touch screen by the sense electrode lead-out wires.

The shapes of the driving electrodes and the sense electrodes can be designed by adopting the following specific proposals: each driving electrode is a rectangular electrode of the same size; each sense electrode is a rectangular electrode of the same size; or, each driving electrode is a rhombic electrode of the same size, and each sense electrode is a rhombic electrode of the same size; or, each driving electrode is a hexagonal electrode of the same size, and each sense electrode is a rhombic electrode of the same size.

On the basis of the mutual capacitance touch screen, the present invention provides a combined mutual capacitance touch screen, which can be realized by adopting the following technical proposals:

A combined mutual capacitance touch screen is designed and manufactured. The combined mutual capacitance touch screen comprises a touch panel made of transparent insulating media and especially at least two mutual capacitance touch units which are covered with the touch panel and arranged closely, wherein the mutual capacitance touch units together fill the touch area of the touch panel. Each of the mutual capacitance touch units comprises a driving layer, a sensor layer and a capacitance medium plane which is held between the driving layer and the sensor layer and made of transparent insulating media. The driving layer comprises plate driving electrodes which are made of transparent conductive materials and distributed at intervals in the same plane, and the sensor layer comprises plate sense electrodes which are made of transparent conductive materials in the same plane. The places where the sense electrodes are distributed in the sensor layer are just over against the intervals between the driving electrodes in the driving layer so that the driving electrodes and the sense electrodes together fill the touch area of each of the mutual capacitance touch units. The driving electrodes are electrically connected with peripheral excitation signal modules of the combined mutual capacitance touch screen, which are corresponding to the mutual capacitance touch units where the driving electrodes are placed, and the sense electrodes are electrically connected with peripheral sense control modules of the combined mutual capacitance touch screen, which are corresponding to the mutual capacitance touch units where the sense electrodes are placed.

The combined mutual capacitance touch screen also comprises shielding layer connecting wires and shielding layer lead-out wires which are made of transparent conductive materials. Each of the mutual capacitance touch unit comprises a shielding layer which is arranged above or below the lower one of the driving layer and the sense layer or embedded in the lower layer. The shielding layer comprises plate shielding electrodes made of transparent conductive materials and shielding electrode lead-out wires, and the shielding electrodes are just over against the areas occupied by the electrodes of the higher one of the driving layer and the sense layer. The shielding electrodes electrically hang; or, respective shielding layers of the mutual capacitance touch units are electrically connected together by the shielding layer connecting wires, and earthed by the shielding layer lead-out wires or electrically connected with peripheral direct current sources of the combined mutual capacitance touch screen; or, respective shielding electrodes of the mutual capacitance touch units are earthed by the shielding electrode lead-out wires or electrically connected with peripheral direct current sources of the combined mutual capacitance touch screen.

Each of the mutual capacitance touch units also comprises a dummy electrode layer which is arranged above or below the higher one of the driving layer and the sense layer or is embedded in the higher layer. The dummy electrode layer comprises plate dummy electrodes made of transparent conductive materials, wherein the dummy electrodes are just over against the areas occupied by the electrodes of the lower one of the driving layer and the sensor layer.

Compared with those in the prior art, the mutual capacitance touch screen and the combined mutual capacitance touch screen have the technical effects that:

The driving electrodes are not over against the sense electrodes in terms of space positions to greatly reduce capacitance C_{B} formed between the driving electrodes and the bottom of the sense electrodes and increase the proportion of capacitance C_{T} formed between the driving electrodes and the top of the sense electrodes to mutual capacitance C; consequently, the proportion of C_{T} change resulted from touch sense to mutual capacitance C at the time of no touch is increased, and the effective capacitivity of the mutual capacitance touch screen is effectively increased;

the shielding electrodes and the dummy electrodes can improve electric fields between the driving electrodes and the sense electrodes to reduce capacitance C_{B} in mutual capacitance C and increase capacitance C_{T}, and the effective capacitivity of the mutual capacitance touch screen is further increased; the dummy electrodes can also make the light transmittance of the mutual capacitance touch screen consistent to increase the performance of the mutual capacitance touch screen;

in addition, the combined mutual capacitance touch screen provides a structure of a large-area touch screen to solve the problem of bandwidth reduction of mutual capacitance paths, which is caused by over resistance resulted from the connection of too many driving electrodes or sense electrodes together.

### DESCRIPTION OF FIGURES

FIG. 1 relates to schematic diagrams of the structure and the principle of the first preferred embodiment of the present invention “mutual capacitance touch screen”, including:

FIG. 1-1 shows the front schematic diagram of the orthographic projection of the sensor layer 300 of the first preferred embodiment;

FIG. 1-2 shows the front schematic diagram of the orthographic projection of the driving layer 200 of the first preferred embodiment;

FIG. 1-3 shows the front schematic diagram of the orthographic projection of the first preferred embodiment;

FIG. 1-4 shows the A-A section schematic diagram of FIG. 1-3;

FIG. 1-5 shows the schematic diagram of electric field distribution when the point O₁ in FIG. 1-4 is not touched;

FIG. 1-6 shows the schematic diagram of electric field distribution when the point O₁ in FIG. 1-4 is touched;

FIG. 2 relates to schematic diagrams of the structure and the principle of the second preferred embodiment of the present invention “mutual capacitance touch screen”, including:

FIG. 2-1 shows the front schematic diagram of the orthographic projection of the shielding layer 400 of the second preferred embodiment;

FIG. 2-2 shows the front schematic diagram of the orthographic projection of the driving layer 200 and the shielding layer 400 of the second preferred embodiment, which are embedded together.

FIG. 2-3 shows the bottom section schematic diagram of the orthographic projection of the second preferred embodiment;

FIG. 2-4 shows the schematic diagram of electric field distribution when the point O₂ in FIG. 2-3 is not touched;

FIG. 2-5 shows the schematic diagram of electric field distribution when the point O₂ in FIG. 2-3 is touched;

FIG. 3 relates to schematic diagrams of the connection modes between the driving layer 200, the shielding layer 400 and peripheral devices of the touch screen of the second preferred embodiment; specifically, four connection modes are included in FIG. 3-1 to FIG. 3-4;

FIG. 4 relates to schematic diagrams of the structure and the principle of the third preferred embodiment of the present invention “mutual capacitance touch screen”, including:

FIG. 4-1 shows the front schematic diagram of the orthographic projection of the dummy electrode layer 500 of the third preferred embodiment;

FIG. 4-2 shows the front schematic diagram of the orthographic projection of the sensor layer 300 and the dummy electrode layer 500 of the third preferred embodiment, which are embedded together;

FIG. 4-3 shows the bottom section schematic diagram of the orthographic projection of the third preferred embodiment;

FIG. 4-4 shows the schematic diagram of electric field distribution when the point O₃ in FIG. 4-3 is not touched;

FIG. 4-5 shows the schematic diagram of electric field distribution when the point O₃ in FIG. 4-3 is touched;

FIG. 5 relates to schematic diagrams of the structure and the principle of the fourth preferred embodiment of the present invention “mutual capacitance touch screen”, including:

FIG. 5-1 shows the bottom section schematic diagram of the orthographic projection of the fourth preferred embodiment;

FIG. 5-2 shows the schematic diagram of electric field distribution when the point O₄ in FIG. 5-1 is not touched;

FIG. 5-3 shows the schematic diagram of electric field distribution when the point O₄ in FIG. 5-1 is touched;

FIG. 6 relates to schematic diagrams of the fifth preferred embodiment of the present invention “mutual capacitance touch screen”, including:

FIG. 6-1 shows the front schematic diagram of the orthographic projection of the driving layer 200 of the fifth preferred embodiment;

FIG. 6-2 shows the front schematic diagram of the orthographic projection of the sensor layer 300 of the fifth preferred embodiment;

FIG. 6-3 shows the front schematic diagram of the orthographic projection of the shielding layer 400 of the fifth preferred embodiment;

FIG. 6-4 shows the front schematic diagram of the orthographic projection of the dummy electrode layer 500 of the fifth preferred embodiment;

FIG. 6-5 shows the section schematic diagram of the fifth preferred embodiment in the B-B direction in FIG. 6-1.

FIG. 7 shows schematic diagram of the sixth preferred embodiment of the present invention “mutual capacitance touch screen”, including:

FIG. 7-1 shows the front schematic diagram of the orthographic projection of the driving layer 200 of the sixth preferred embodiment;

FIG. 7-2 shows the front schematic diagram of the orthographic projection of the sensor layer 300 of the sixth preferred embodiment;

FIG. 7-3 shows the front schematic diagram of the orthographic projection of the shielding layer 400 of the sixth preferred embodiment;

FIG. 7-4 shows the front schematic diagram of the orthographic projection of the dummy electrode layer 500 of the sixth preferred embodiment;

FIG. 7-5 shows the section schematic diagram of the sixth preferred embodiment in the C-C direction in FIG. 7-1.

FIG. 8 relates to schematic diagrams of the seventh preferred embodiment of the combined mutual capacitance touch screen of the present invention, including:

FIG. 8-1 shows the front schematic diagram of the orthographic projection of the seventh preferred embodiment;

FIG. 8-2 shows the bottom schematic diagram of the orthographic projection of the seventh preferred embodiment.

FIG. 9 relates to schematic diagrams of the eighth preferred embodiment of the present invention “combined mutual capacitance touch screen”, including:

FIG. 9-1 shows the front schematic diagram of the orthographic projection of the eighth preferred embodiment;

FIG. 9-2 shows the bottom schematic diagram of the orthographic projection of the eighth preferred embodiment.

FIG. 10 relates to schematic diagrams of the ninth preferred embodiment of the present invention “combined mutual capacitance touch screen”, including:

FIG. 10-1 shows the front schematic diagram of the orthographic projection of the ninth preferred embodiment;

FIG. 10-2 shows the bottom schematic diagram of the orthographic projection of the ninth preferred embodiment.

FIG. 11 relates to schematic diagrams of the structure and the principle of the mutual capacitance touch screen in the prior art, including:

FIG. 11-1 shows the front schematic diagram of the orthographic projection of the touch screen;

FIG. 11-2 shows the bottom section schematic diagram of FIG. 11-1;

FIG. 11-3 shows the schematic diagram of electric field distribution when the touch screen is not touched;

FIG. 11-4 shows the schematic diagram of electric field distribution when the touch screen is touched.

### MODE OF CARRYING OUT THE INVENTION

All the preferred embodiments are further detailed as follows in conjunction with the figures.

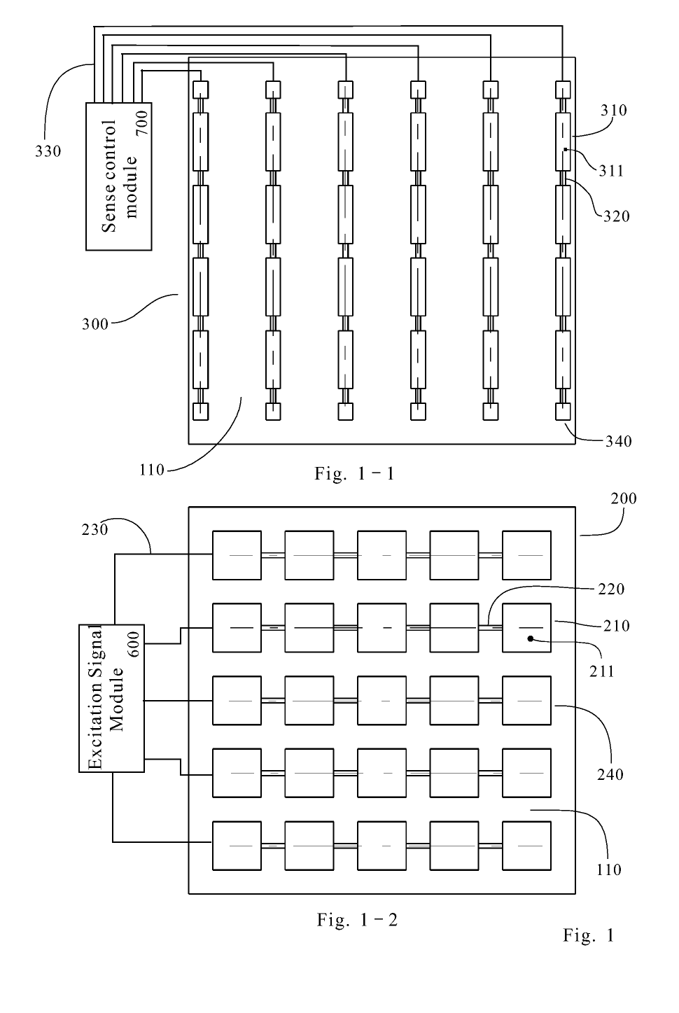

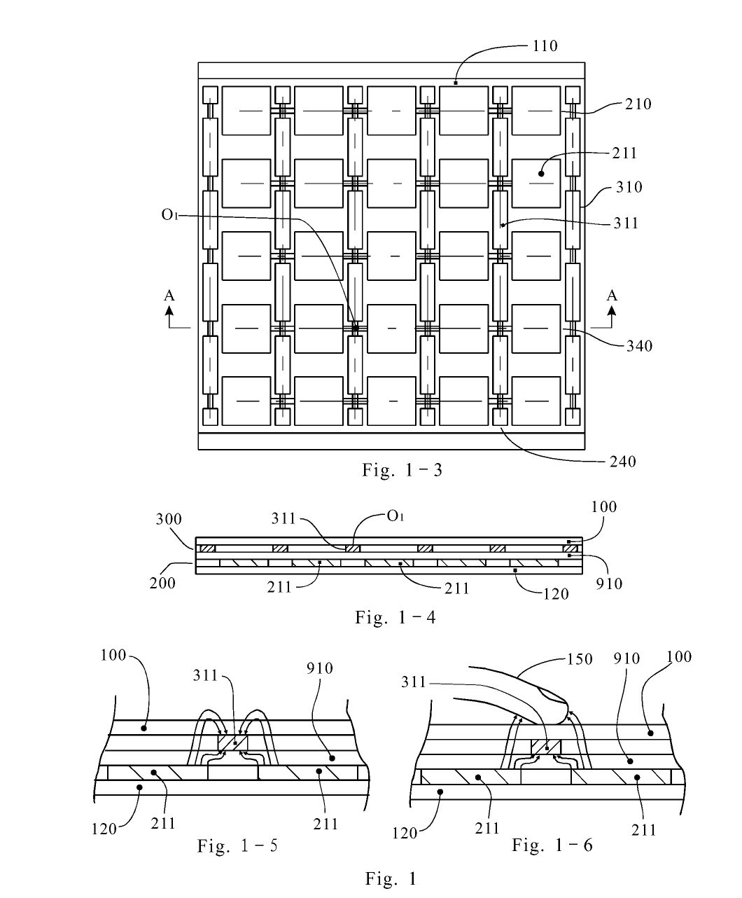

The present invention relates to a mutual capacitance touch screen for covering the surface of a display screen of a graphical or videographic display device and controlling the contents displayed by the graphical or videographic display device through a peripheral control device. As shown in FIG. 1 to FIG. 7, the mutual capacitance touch screen comprises the touch plane 100 made of transparent insulating media, the driving layer 200 and the sensor layer 300 covered with the touch plane 100, and the capacitance medium plane 910 which is made of transparent insulating media and held between the driving layer 200 and the sensor layer 300. In addition, a protection plane 120 made of transparent insulating materials can also be arranged, and the driving layer 200, the sensor layer 300 and the capacitance medium plane 910 are arranged between the touch plane 100 and the protection plane 120 which comes into contact with the display screen of the graphical or videographic display device.

The driving layer 200 comprises plate driving electrodes 210 which are made of transparent conductive materials and distributed at intervals in the same plane; the sensor layer 300 comprises plate sense electrodes 310 which are made of transparent conductive materials and distributed at intervals in the same plane; and the places where the sense electrodes 310 are distributed in the sensor layer 300 are just over against the intervals between the driving electrodes 210 in the driving layer 200 so that the driving electrodes 210 and the sense electrodes 310 together fill the touch area 110 of the touch plane 100. The driving electrodes 210 are electrically connected with the peripheral excitation signal modules 600 of the touch screen, and the sense electrodes 310 are electrically connected with the peripheral sense control modules 700 of the touch screen.

The driving electrodes 210 and the sense electrodes 310 of the mutual capacitance touch screen can not be just over against each other, so capacitance C_{B} formed between the driving electrodes 210 and the bottom of the sense electrodes 310 is smaller than capacitance C_{B} formed between the driving wires 210′ and the bottom of the sense wires 310′ in the prior art. As a result, the proportion of capacitance C_{B} of the present invention to mutual capacitance C is small so that the effective capacitivity of mutual capacitance C is raised.

The shapes and the situations of connection distribution in the corresponding driving layer 200 and the corresponding sensor layer 300 of the driving electrodes 210 and the sense electrodes 310 of the mutual capacitance touch screen can be varied, and the present invention discloses several shapes and situations of connection distribution, which are suitable for application and practice of the first preferred embodiment to the seventh preferred embodiment.

The mutual capacitance touch screen in each preferred embodiment adopts the following technical proposal: the mutual capacitance touch screen also comprises the driving electrode connecting wires 220 and the sense electrode connecting wires 320 which are made of transparent conductive materials, the driving electrode lead-out wires 230 and the sense electrode lead-out wires 330; the driving electrodes 210 are grouped and connected in series by the driving electrode connecting wires 220 which are mutually collinear or parallel in the driving layer 200; the sense electrodes 310 are grouped and connected in series by the sense electrode connecting wires 320 which are mutually collinear or parallel in the sensor layer 300; the driving electrode connecting wires 220 are perpendicular to the sense electrode connecting wires 320; each driving electrode group 240 is electrically connected with the peripheral excitation signal module 600 of the touch screen by the driving electrode lead-out wires 230; and each sense electrode group 340 is electrically connected with the peripheral sense control modules 700 by the sense electrode lead-out wires 330. As shown in FIGS. 1 to 7, the position relation of the driving electrode connecting wires 220 or the sense electrode connecting wires 320 comprises collinearity and parallelism in each preferred embodiment; namely, the geometric centers of the driving electrodes 210 in the driving electrode groups 240 and the driving electrode connecting wires 220 are on the same straight line, and the straight lines on which the driving electrode connecting wires 220 of the driving electrode groups 240 are positioned are mutually parallel; the geometric centers of the sense electrodes 310 in the sense electrode groups 340 and the sense electrode connecting wires 320 are on the same straight line, and the straight lines on which the sense electrode connecting wires 320 of the sense electrode groups 340 are positioned are mutually parallel; and that is, for the driving electrode connecting wires 220 in the driving layer 200 and the sense electrode connecting wires 320 in the sensor layer 300, the electrode connecting wires in the electrode groups are collinear, and the electrode connecting wires between the electrode groups are parallel.

In the first preferred embodiment as shown in FIG. 1, each driving electrode 210 is a rectangular driving electrode 211, and 25 rectangular driving electrodes 211 exist; and each sense electrode 310 is a rectangular sense electrodes 311, and 36 rectangular sense electrodes 311 exist.

As shown in FIG. 1-1, the rectangular sense electrodes 311 are grouped and connected in series in six sense electrode groups 340 through sense electrode connecting wires 320, and the geometric centers of the rectangular sense electrodes 311 in each sense electrode group 340 and the connecting wires 320 of the rectangular sense electrodes 310 are on the same straight line; the straight lines on which the sense electrode connecting wires 320 in the sense electrode groups 340 are positioned are mutually parallel. Each sense electrode group 340 is electrically connected with the peripheral sense control modules 700 of the touch screen by the sense electrode lead-out wires 330.

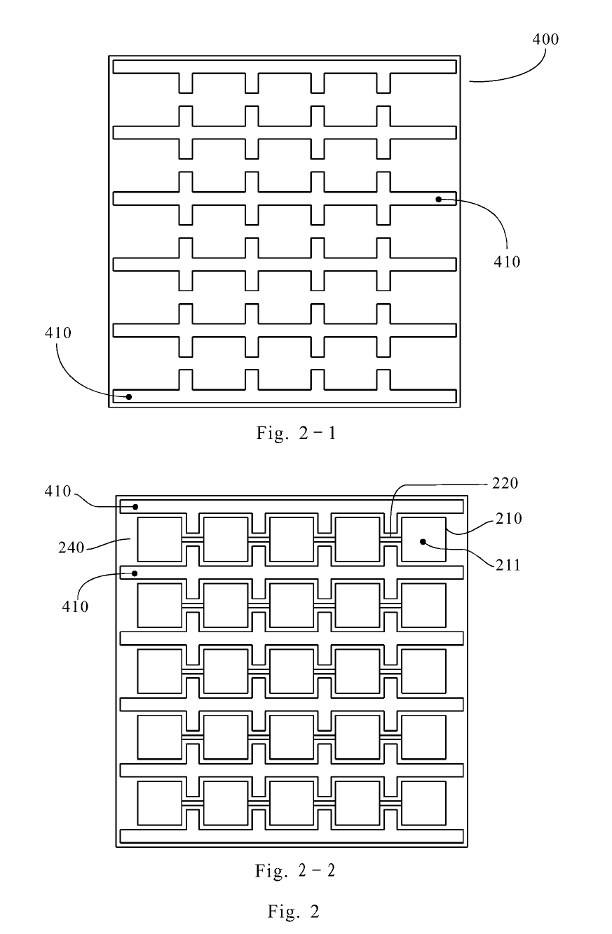

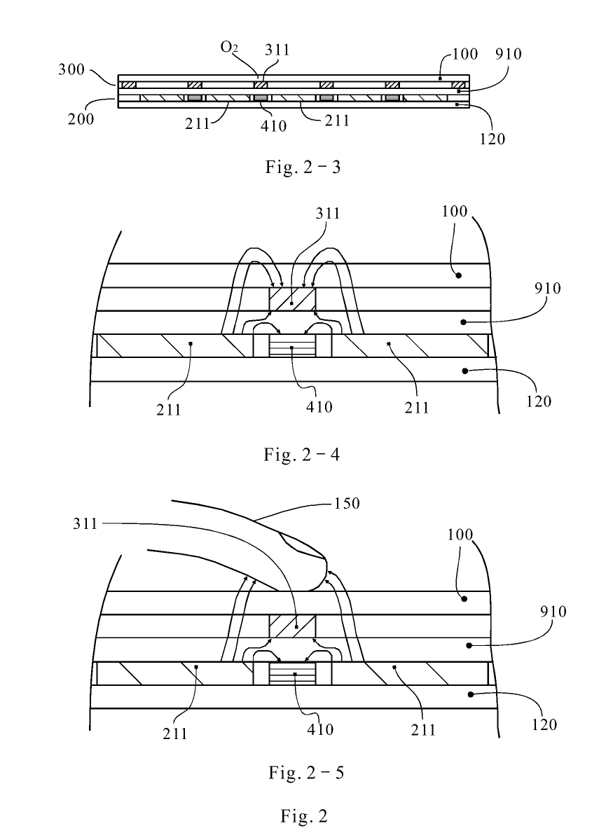

As shown in FIG. 1-2, the rectangular driving electrodes 211 are grouped and connected in series in five driving electrode groups 240 by the driving electrode connecting wires 220, and the geometric centers of the rectangular driving electrodes 211 in each driving electrode group 240 and the driving electrode connecting wires 220 are on the same straight line; the straight lines on which the driving electrode connecting wires 220 in the driving electrode groups 240 are positioned are mutually parallel. Each driving electrode group 240 is electrically connected with the peripheral excitation signal modules 600 of the touch screen by the driving electrode lead-out wires 230.

As shown in FIG. 1-3, the places where the rectangular sense electrodes 311 are distributed in the sensor layer 300 are just over against the intervals between the rectangular driving electrodes 211 in the driving layer 200, and the rectangular driving electrodes 211 and the rectangular sense electrodes 311 together fill the touch area 110 of the touch screen. The driving electrode connecting wires 220 are perpendicular to the sense electrode connecting wires 320.

As shown in FIGS. 1-3 and 1-4, the areas occupied by the rectangular sense electrodes 311 and the areas occupied by the rectangular driving electrodes 211 are complementary in the entire touch area 110 so that the rectangular sense electrodes 311 can not be just over against the rectangular driving electrodes 211.

In terms of the point O₁ shown in FIG. 1-4, when the point O₁ is not touched, the situation of electric field distribution at the point O₁ is shown in FIG. 1-5; when the point O₁ is touched by the finger 150, the situation of electric field distribution at the point O₁ is shown in FIG. 1-6. Because the bottom of the rectangular sense electrodes 311 is not just over against the rectangular driving electrodes 211, the value of capacitance C_{B} formed between the bottom of the rectangular sense electrodes 311 and the rectangular driving electrodes 211 is much smaller than that in the prior art; namely, the proportion of capacitance C_{B} formed between the bottom of the rectangular sense electrodes 311 and the rectangular driving electrodes 211 to mutual capacitance C at the point O₁ is greatly reduced so that the effective capacitivity of mutual capacitance C of the mutual capacitance touch screen is effectively increased.

The second preferred embodiment is shown in FIG. 2: The driving layer 200 and the sensor layer 300 are exactly the same as those of the first example embodiment but the shielding layer 400 is added, wherein the shielding layer 400 is arranged above or below the lower one of the driving layer 200 and the sensor layer 300 or is embedded in the lower layer. The shielding layer 400 comprises the plate shielding electrodes 410 made of transparent conductive materials, and the shielding electrodes 410 are just over against the areas occupied by the electrodes in the higher one of the driving layer 200 and the sensor layer 300.

In the preferred embodiment, the sensor layer 300 is positioned above the driving layer 200; consequently, as shown in FIG. 2-1, the places where the shielding electrodes 410 are distributed in the shielding layer 400 are over against the areas occupied by the sense electrodes 310 in the sensor layer 300, and the shielding electrodes 410 are connected into six shielding electrodes 410; to tell from another angle, the places where the shielding electrodes 410 are distributed in the shielding layer 400 are just over against the intervals between the driving electrodes 210 in the driving layer 200.

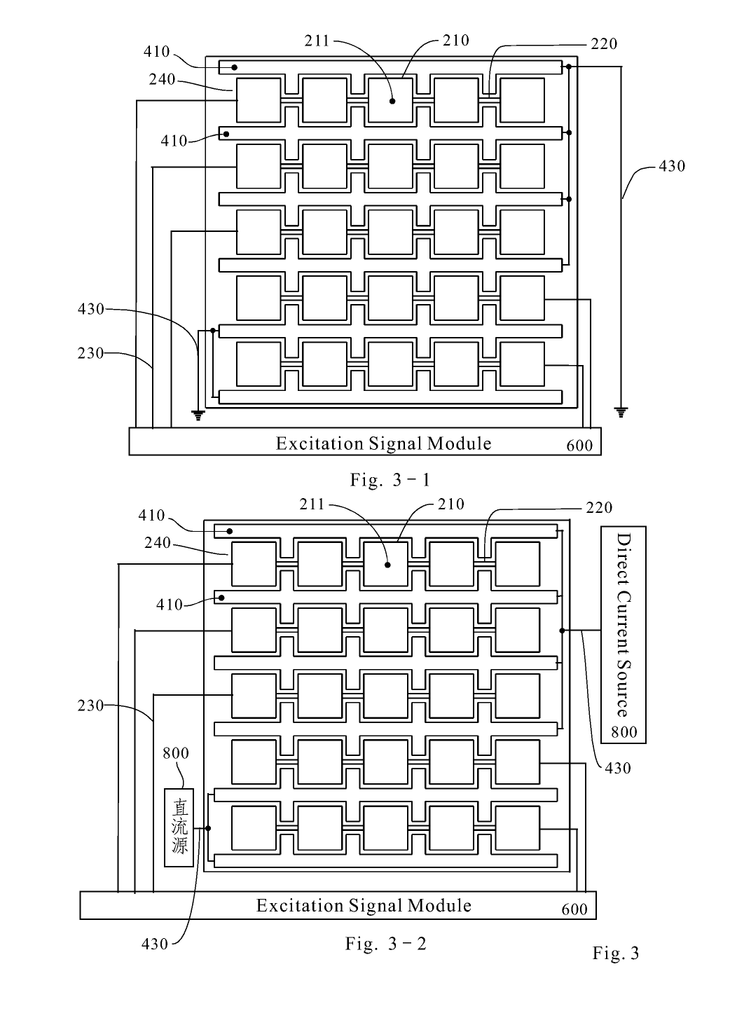

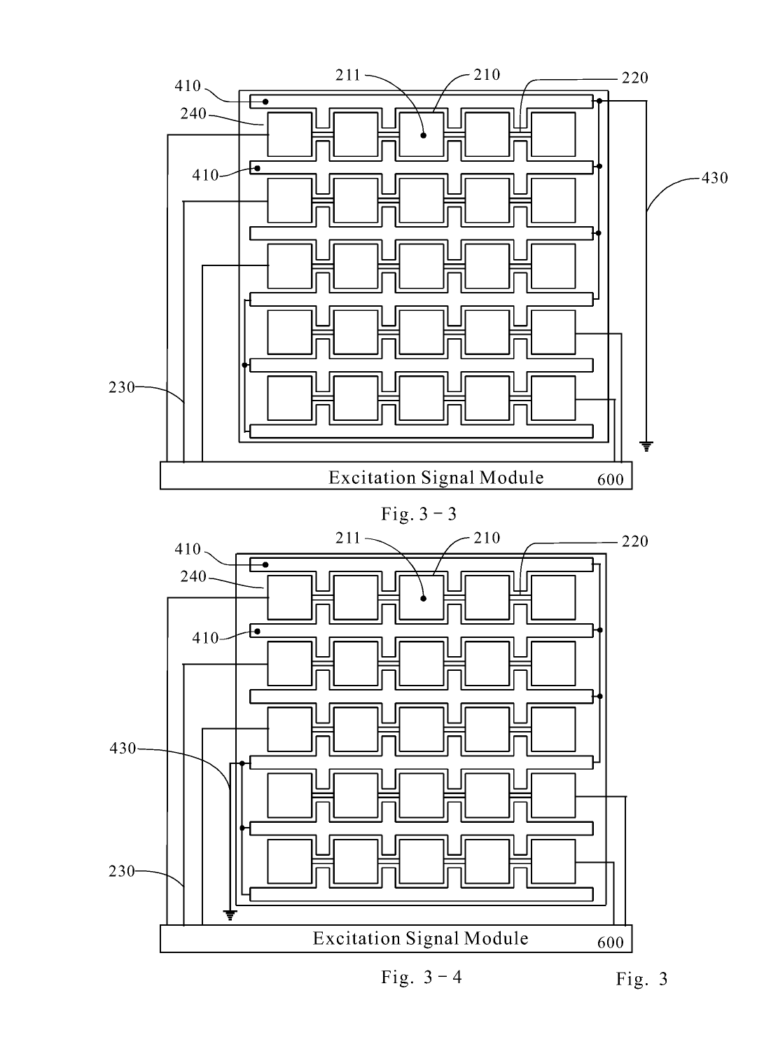

As shown in FIG. 2-2, the areas occupied by the shielding electrodes 410 and the rectangular driving electrodes 211 are complementary. In the example embodiment, the shielding layer 400 and the driving layer 200 are embedded as shown in FIG. 2-3; namely, the shielding layer 400 and the driving layer 200 are in the same layer.

In terms of the point O₂ shown in FIG. 2-3, when the point O₂ is not touched, the situation of electric field distribution at the point O₂ is shown in FIG. 2-4; when the point O₂ is touched by the finger 150, the situation of electric field distribution at the point O₂ is shown in FIG. 2-5. As shown in FIGS. 2-4 and 2-5, the action of the shielding electrode 410 is to change the electric fields at the bottom of the rectangular sense electrodes 311 so as to further reduce the capacitance formed between the bottom of the rectangular sense electrodes 311 and the rectangular driving electrodes 211, which can be understood in the way that the shielding electrodes 410 suck part of the electric field lines in the electric fields of the rectangular driving electrodes 211 and the bottom of the rectangular sense electrodes 311.

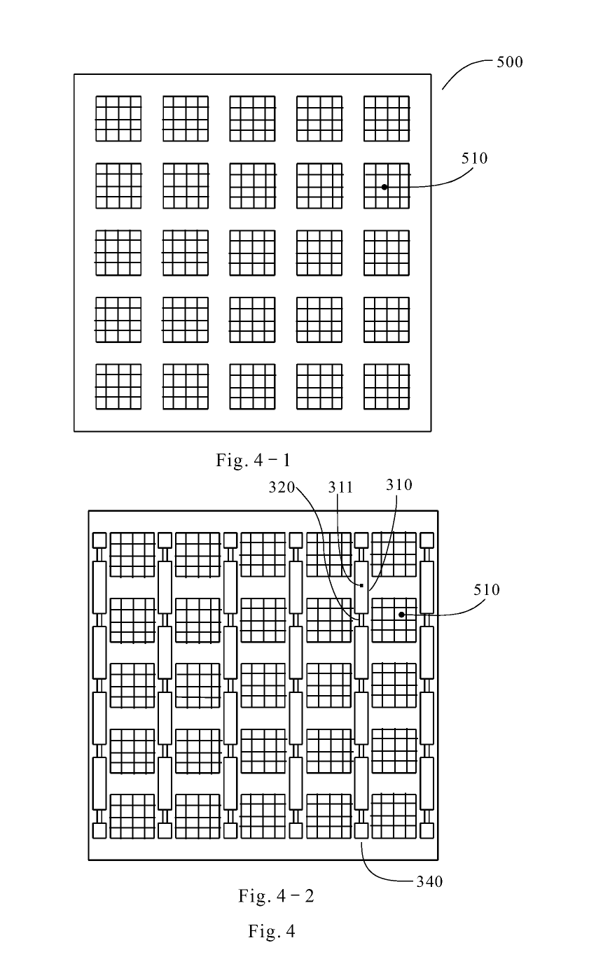

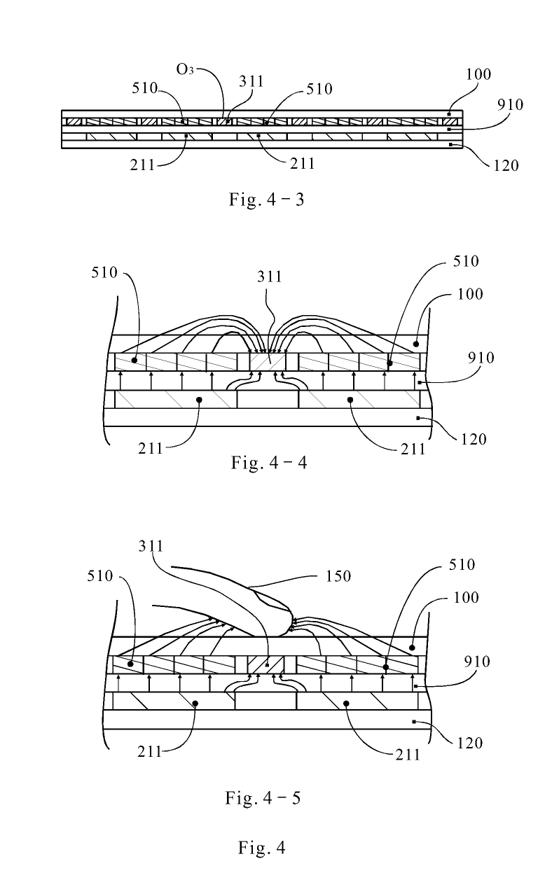

The shielding electrodes 410 can electrically hang; namely, the shielding electrodes 410, are not electrically connected with any peripheral excitation signal, alternating current ground and direct current source of the mutual capacitance touch screen. The following proposal can also be adopted: as shown in FIG. 3, the shielding layer 400 also comprises the shielding electrode lead-out wires 430, and the shielding electrodes 410 are earthed or electrically connected with the peripheral direct current sources 800 of the touch screen by the shielding electrode lead-out wires 430. In addition, in order to reduce the number of the shielding electrode lead-out wires 430, all the shielding electrodes 410 are electrically connected with the direct current sources 800 or directly connected with the alternating current grounds generally by one or two shielding electrode lead-out wires 430. Meanwhile, the shielding electrode lead-out wires 430, the driving electrode lead-out wires 230 and the sense electrode lead-out wires 330 are prevented from being crossed as much as possible. In terms of the second example embodiment, four lead-out situations of the shielding electrode lead-out wires 430 are shown in FIG. 3, wherein FIGS. 3-1 and 3-2 show that all the shielding electrodes 410 are electrically connected with the alternating current ground or the direct current sources 800 by two shielding electrode lead-out wires 430, and FIGS. 3-3 and 3-4 show that all the shielding electrodes 410 are electrically connected with the alternating current grounds by one shielding electrode lead-out wire 430. In terms of other preferred embodiments with the shielding layer 400, the way in which the shielding electrodes 410 are earthed or electrically connected with the peripheral direct current sources 800 of the touch screen can be any one shown in FIG. 4 and also can be other ways in which the shielding electrode lead-out wires 430 and the driving electrode lead-out wires 230 are mutually disjoint in space.

In terms of the third preferred embodiment as shown in FIG. 4, the driving layer 200 and the sensor layer 300 are exactly the same as those of the first preferred embodiment but the dummy electrode layer 500 is added, wherein the dummy electrode layer 500 is arranged above or below the higher one of the driving layer 200 and the sensor layer 300 or is embedded in the higher layer. The dummy electrode layer 500 comprises the plate dummy electrodes 510 made of transparent conductive materials, and the dummy electrodes 510 are just over against the areas occupied by the electrodes in the lower one of the driving layer 200 and the sensor layer 300.

In the preferred embodiment, the driving layer 200 is positioned below the sensor layer 300; consequently, as shown in FIG. 4-1, the dummy electrodes 510 are just over against the areas occupied by the electrodes in the sensor layer 200; to tell from another angle, the places where the dummy electrodes 510 are distributed in the shielding layer 400 are just over against the areas occupied by the driving electrodes 210 in the driving layer 200. The places where a plurality of dummy electrodes 510 filling the area can be distributed or only one dummy electrode 510 can also be arranged in the dummy electrode layer 500 are just over against the area of some driving electrode 210 of the driving layer 200. In the preferred embodiment, the places where sixteen dummy electrodes 510 with smaller area are closely distributed in the dummy electrode layer 500 are over against the driving electrode 210, and the structure can make the electric fields distributed more uniformly, which is favorable for touch sense. The dummy electrodes are not mutually connected or electrically connected with any signal excitation source, direct current source or ground wire like common electrodes but are in the electrically hanging state, so the name of a dummy electrode or Dummy Cell is given.

As shown in FIG. 4-2, the areas occupied by the dummy electrodes 410 and the rectangular sense electrodes 311 are complementary. In the preferred embodiment, the dummy electrode layer 500 and the sensor layer 300 are embedded as shown in FIG. 4-3; namely, the dummy electrode layer 500 and the sensor layer 300 are in the same layer.

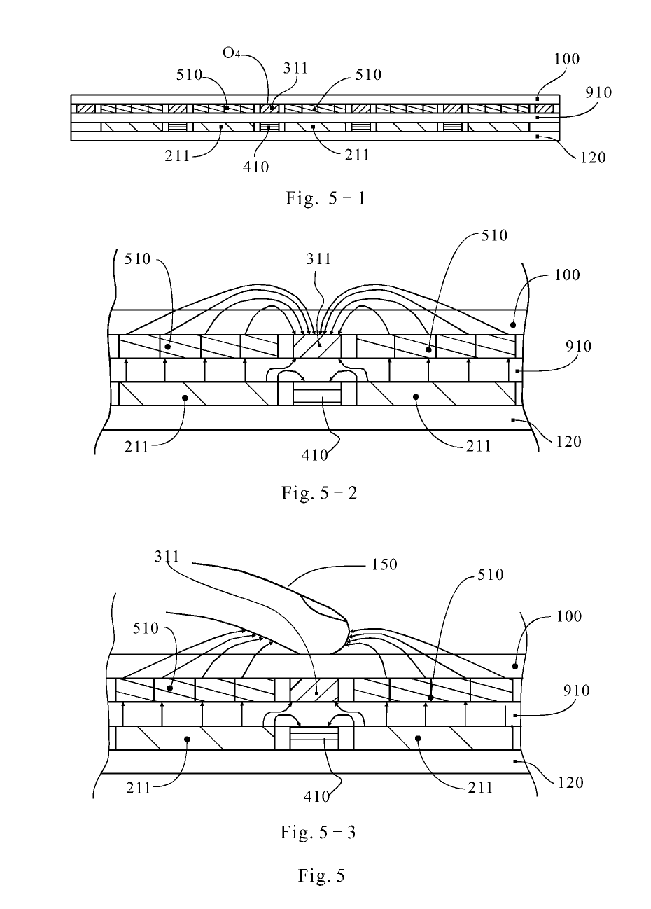

In terms of the point O₃ shown in FIG. 4-3, when the point O₃ is not touched, the situation of electric field distribution at the point O₃ is shown in FIG. 4-4; when the point O₃ is touched by the finger 150, the situation of electric field distribution at the point O₃ is shown in FIG. 5-5. As shown in FIGS. 4-4 and 4-5, the action of the dummy electrodes 510 is to change the electric field at the top of the rectangular sense electrode 311 so that capacitance C_{T} formed between the top of the rectangular sense electrode 311 and the rectangular driving electrodes 211 is increased to further widen the range of C_{T}, which can be understood in the way that the dummy electrodes 510 increase electric field lines of the electric field of the rectangular driving electrodes 211 and the top of the rectangular sense electrode 311; in addition, the action of the dummy electrode 510 is to make the light transmittances of the touch screen consistent.

The fourth preferred embodiment is shown in FIG. 5: the driving layer 200 and the sensor layer 300 are exactly the same as those of the first preferred embodiment, but the shielding layer 400 which is the same as that of the second preferred embodiment and the dummy electrode layer 500 which is the same as that of the third preferred embodiment are added.

As shown in FIG. 5-1, the shielding layer 400 and the driving layer 200 are embedded together, and the dummy electrode layer 500 and the sense layer 300 are embedded together.

In terms of the point O₄ shown in FIG. 5-1, when the point O₄ is not touched, the situation of electric field distribution at the point O₄ is shown in FIG. 5-2; when the point O₄ is touched by the finger 150, the situation of electric field distribution at the point O₄ is shown in FIG. 5-3. As shown in FIGS. 6-2 and 5-3, under the combined action of the shielding electrodes 410 and the dummy electrodes 510, capacitance C_{B} formed between the bottom of the rectangular sense electrodes 311 and the rectangular driving electrodes 211 is further reduced, and capacitance C_{T} formed between the top of the rectangular sense electrodes 311 and the rectangular driving electrodes 211 is further increased so that the effective capacitivity of mutual capacitance C is further increased.

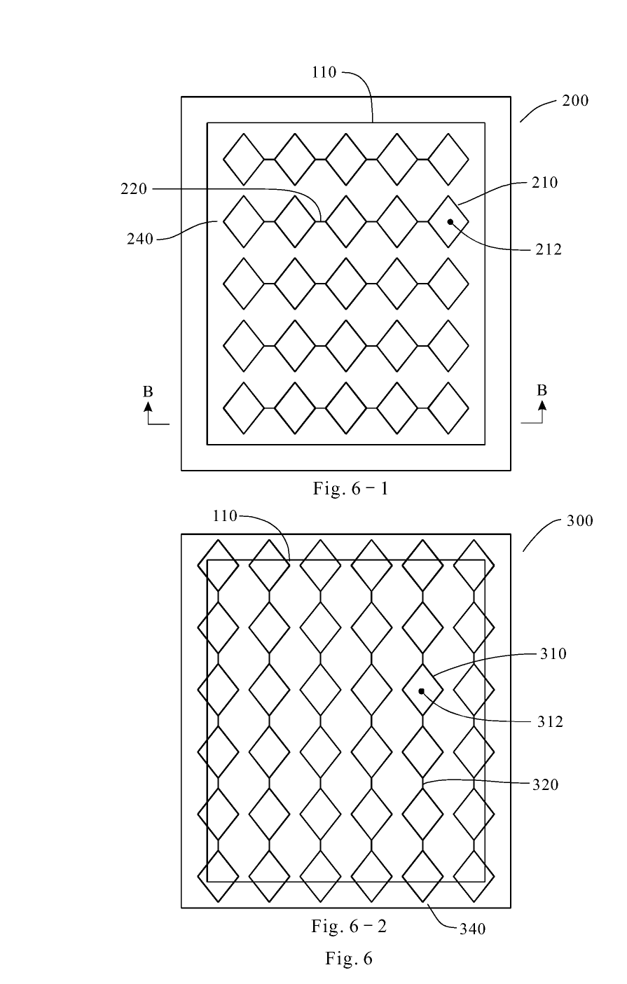

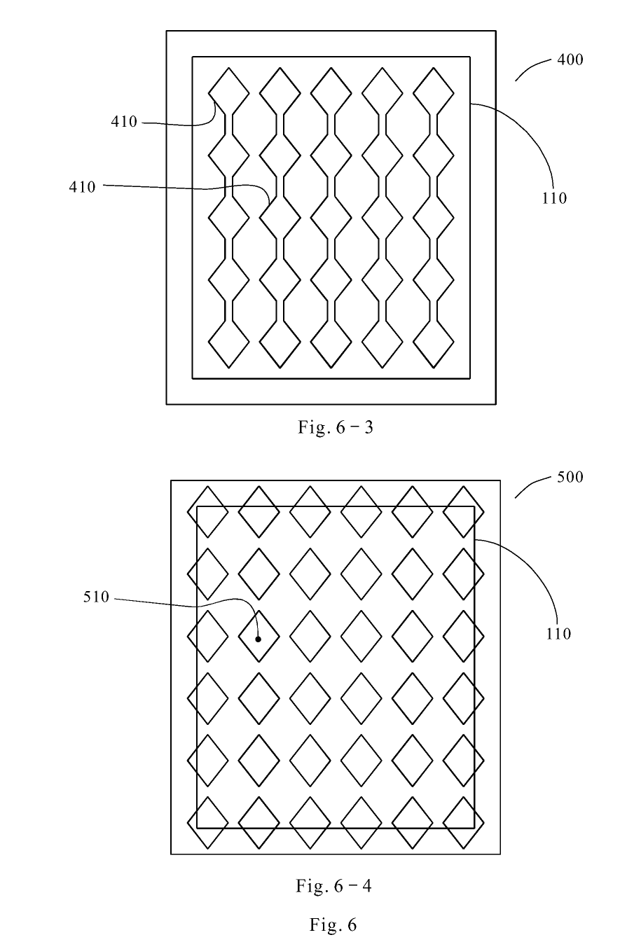

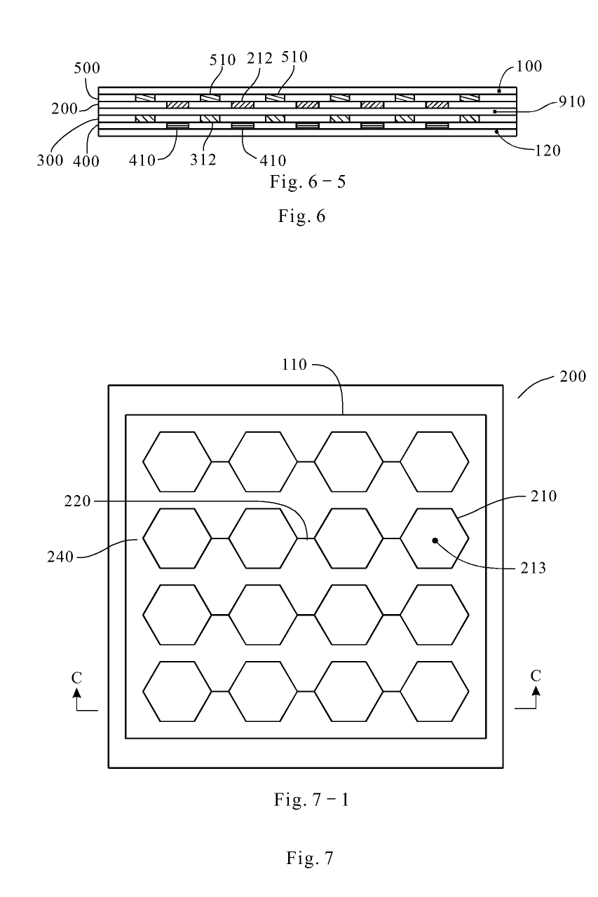

The fifth preferred embodiment is shown in FIG. 6: The mutual capacitance touch screen comprises the driving layer 200, the sensor layer 300, the shielding layer 400 and the dummy electrode layer 500.

As shown in FIG. 6-1, the driving layer 200 comprises the driving electrodes 210 which are rhombic driving electrodes 212, and the preferred embodiment has 25 rhombic driving electrodes 212. The rhombic driving electrodes 212 are grouped and connected in series in five driving electrode groups 240 through the driving electrode connecting wires 220, wherein the geometric centers of the rhombic driving electrodes 212 in each driving electrode group 240 and the driving electrode connecting wires 220 are on the same straight line, and the straight lines on which the connecting wires 220 of the driving electrodes in the driving electrode groups 240 are positioned are parallel. The situations of electrical connection between the driving electrode groups 240 and the peripheral excitation signal modules 600 of the touch screen are the same as those of the first preferred embodiment.

As shown in FIG. 6-2, the driving layer 300 comprises the sense electrodes 310 which are rhombic driving electrodes 312, and the preferred embodiment has 36 rhombic sense electrodes 312. The rhombic sense electrodes 312 are grouped and connected in series in six sense electrode groups 340 through the sense electrode connecting wires 320, wherein the geometric centers of the rhombic sense electrodes 312 in each sense electrode group 340 and the rhombic sense electrode connecting wires 320 are on the same straight line, and the straight lines on which the sense electrode connecting wires 320 in the sense electrode groups 340 are positioned are parallel. The situations of electrical connection between the sense electrode groups 340 and the peripheral sense control modules 700 of the touch screen are the same as those of the first preferred embodiment.

The places where the rhombic sense electrodes 312 are distributed in the sensor layer 300 are just over against the intervals between the rhombic driving electrodes 212 in the driving layer 200 so that the rhombic driving electrodes 212 and the rhombic sense electrodes 312 together fill the touch area 110 of the touch screen. The connecting wires 220 of the driving electrodes are perpendicular to the sense electrode connecting wires 320.

In the fifth preferred embodiment, the driving layer 200 is positioned above the sensor layer 300; as shown in FIG. 6-3, the shielding layer 400 comprises the plate shielding electrodes 410 made of transparent conductive materials, and the shielding electrodes 410 are just over against the areas occupied by the rhombic driving electrodes 212 in the driving layer 200; namely, the places where the shielding electrodes 410 are distributed in the shielding layer 400 are just over against the intervals between the sense electrodes 310 in the sensor layer 300. The action of the shielding layer 400 of the preferred embodiment is basically the same as that of the second and fourth preferred embodiments.

In the fifth preferred embodiment, the driving layer 200 is positioned above the sensor layer 300; as shown in FIG. 6-4, the dummy electrode layer 500 comprises plate dummy electrodes 510 which are made of transparent conductive materials and distributed at intervals, the dummy electrodes 510 of the preferred embodiment are rhombic, and the dummy electrodes 510 are just over against the areas occupied by the rhombic sense electrodes 312 in the sensor layer 300; namely, the places where the dummy electrodes 510 are distributed in the dummy electrode layer 500 are just over against the intervals between the driving electrodes 210 in the driving layer 200. At the places of the dummy electrode layer 500 which are just over against certain sense electrode 310 of the sensor layer 300, only one dummy electrode 510 is used. The action of the dummy electrode layer 500 of the preferred embodiment is basically the same as that of the third and fourth preferred embodiments.

As shown in FIG. 6-5, the dummy electrode layer 500 is positioned above the driving layer 200, and the shielding layer 400 is positioned below the sensor layer 300. Mutual capacitance C formation and the situation of electric field distribution of the preferred embodiment are basically the same as those of the fourth preferred embodiment, so the embodiment can effectively improve the effective capacitivity of mutual capacitance C.

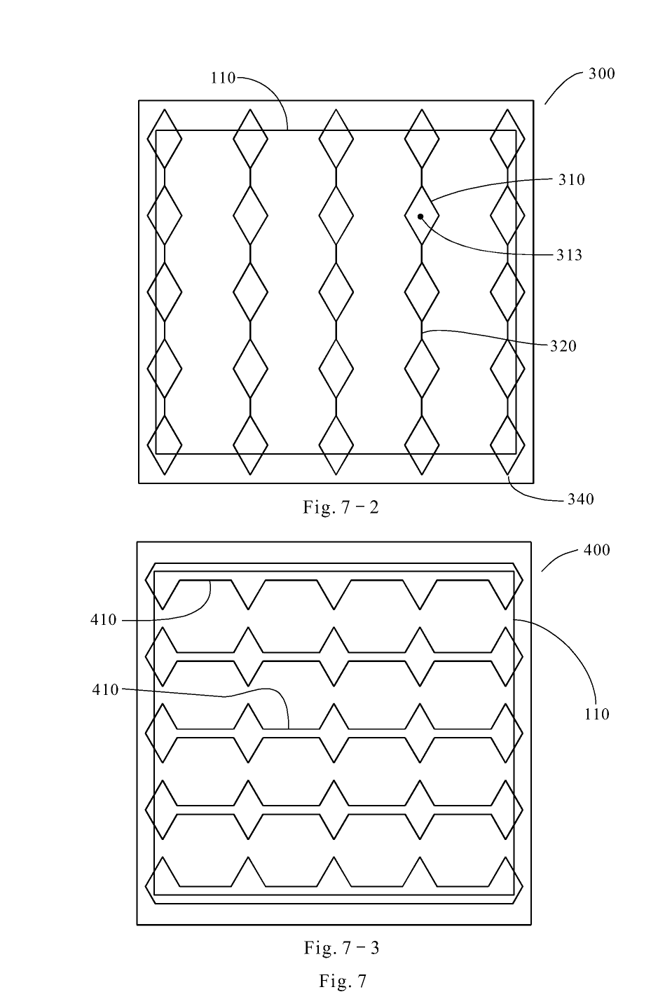

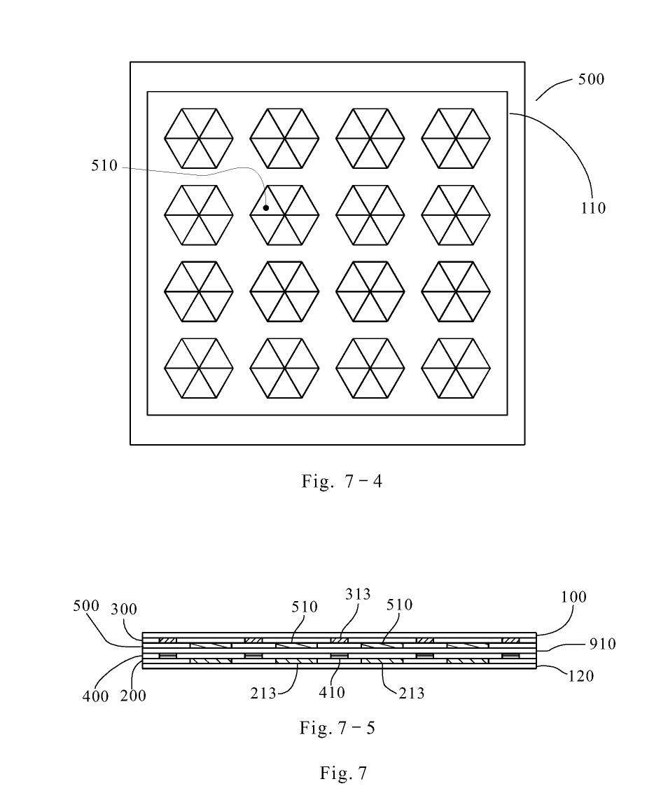

The sixth preferred embodiment is shown in FIG. 7: The mutual capacitance touch screen comprises the driving layer 200, the sensor layer 300, the shielding layer 400 and the dummy electrode layer 500.

As shown in FIG. 7-1, the driving layer 200 comprises the driving electrodes 210 which are hexagonal driving electrodes 213, and the preferred embodiment has 16 hexagonal driving electrodes 213. The hexagonal driving electrodes 213 are grouped and connected in series in four driving electrode groups 240 through the driving electrode connecting wires 220, wherein the geometric centers of the hexagonal driving electrodes 213 of the driving electrode groups 240 and the driving electrode connecting wires 220 are on the same straight line, and the straight lines on which the driving electrode connecting wires 220 in the driving electrode groups 240 are positioned are parallel. The situations of electrical connection between the driving electrode groups 240 and the peripheral excitation signal modules 600 of the touch screen are the same as those of the first preferred embodiment.

As shown in FIG. 7-2, the sensor layer 300 comprises the sense electrodes 310 which are rhombic sense electrodes 313, and the preferred embodiment has 25 rhombic sense electrodes 313. The rhombic sense electrodes 313 are grouped and connected in series in five sense electrode groups 340 through the sense electrode connecting wires 320, wherein the geometric centers of the rhombic sense electrodes 313 in each sense electrode group 340 and the rhombic sense electrode connecting wires 320 are on the same straight line, and the straight lines on which the sense electrode connecting wires 320 in the sense electrode groups 340 are positioned are parallel. The situations of electrical connection between the sense electrode groups 340 and the peripheral sense control modules 700 of the touch screen are the same as those of the first preferred embodiment.

The places where the rhombic sense electrodes 313 are distributed in the sensor layer 300 are just over against the intervals between the hexagonal driving electrodes 213 in the driving layer 200 so that the hexagonal driving electrodes 213 and the rhombic sense electrodes 313 together fill the touch area 110 of the touch screen. The driving electrode connecting wires 220 are perpendicular to the sense electrode connecting wires 320.

In the sixth preferred embodiment, the driving layer 200 is positioned below the sensor layer 300; as shown in FIG. 7-3, the shielding layer 400 comprises plate shielding electrodes 410 which are made of transparent conductive materials, and the shielding electrodes 410 are just over against the areas occupied by the sense electrodes 310 in the sensor layer 300; namely, the places where the shielding electrodes 410 are distributed in the shielding layer 400 are just over against the intervals between the driving electrodes 210 in the driving layer 200. The action of the shielding layer 400 of the preferred embodiment is basically the same as that of the second and fourth preferred embodiments.

In the sixth preferred embodiment, the driving layer 200 is positioned below the sensor layer 300; as shown in FIG. 7-4, the dummy electrode layer 500 comprises the plate dummy electrodes 510 which are made of transparent conductive materials and distributed at intervals, wherein the dummy electrodes 510 are just over against the areas occupied by the driving electrodes 210 in the driving layer 200; namely, the places where the dummy electrodes 510 are distributed in the dummy electrode layer 500 are just over against the intervals between the sense electrodes 310 in the sensor layer 300. The dummy electrode 510 of the preferred embodiment is in the shape of a triangle, and six dummy electrodes 510 need to be arranged in the places of the dummy electrode layer 500, which are just over against the places where one hexagonal driving electrode 213 is positioned in the driving layer 200; as stated above, owing to the design, the area of the dummy electrode 510 is reduced, and the electric field distribution is uniform, which is favorable for touch sense. The action of the dummy electrode layer 500 of the preferred embodiment is basically the same as that of the third and fourth preferred embodiments.

As shown in FIG. 7-5, the dummy electrode layer 500 is positioned below the sensor layer 300, and the shielding layer 400 is positioned above the driving layer 200. Mutual capacitance C formation and the situation of electric field distribution of the preferred embodiment are basically the same as those of the fourth preferred embodiment, so the preferred embodiment can effectively increase the effective capacitivity of mutual capacitance C.

The present invention also relates to a combined mutual capacitance touch screen which is applicable to the touch screen with larger area. When the area of the mutual capacitance touch screen is larger, the number of the driving electrodes and sense electrodes needs to be increased, over resistance caused by long electrode group results in the reduction of the bandwidth of the mutual capacitance paths, which brings inconvenience to circuit driving and sensing. In order to avoid the situation, the present invention provides the combined mutual capacitance touch screen which is formed by the combination of mutual capacitance touch screens.

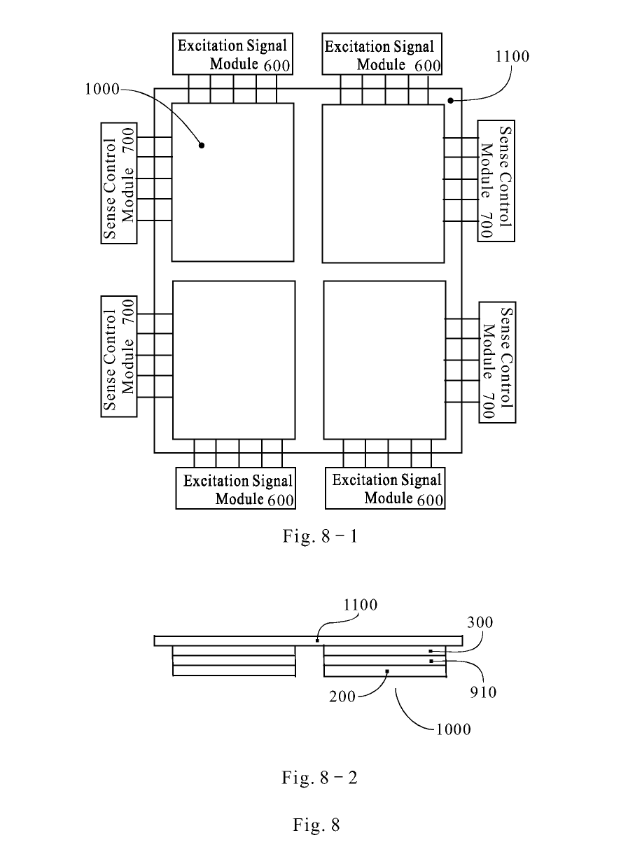

As shown in FIGS. 8 to 10, the combined mutual capacitance touch screen comprises a touch panel 1100 made of transparent insulating media, particularly at least two mutual capacitance touch units 1000 which are covered with the touch panel 1100 and distributed closely, and the mutual capacitance touch units 1000 together fill the touch area of the touch panel 1100. The structure of the mutual capacitance touch units 1000 similar to that of the mutual capacitance touch screen comprises the driving layer 200, the sensor layer 300, and a capacitance medium plane 910 which is made of transparent insulating media and is held between the driving layer 200 and the sensor layer 300. The driving layer 200 comprises plate driving electrodes 210 which are made of transparent conductive materials and distributed at intervals in the same plane; the sensor layer 300 comprises plate sense electrodes 310 which are made of transparent conductive materials and distributed at intervals in the same plane; the places where the sense electrodes 310 are distributed in the sensor layer 300 are just over against the intervals between the driving electrodes 210 in the driving layer 200 so that the driving electrodes 210 and the sense electrodes 310 together fill the touch area 110 of the mutual capacitance touch units 1000 occupied by the driving electrodes 210 and the sense electrodes 310; and the driving electrodes 210 are electrically connected with the peripheral excitation signal modules 600 of the combined mutual capacitance touch screen and are corresponding to the mutual capacitance touch units 1000 where the sense electrodes 310 are placed, and the sense electrodes 310 are electrically connected with the peripheral sense control modules 700 of the combined mutual capacitance touch screen and are corresponding to the mutual capacitance touch units 1000 where the sense electrodes 310 are placed.

The seventh preferred embodiment is shown in FIG. 8: The combined mutual capacitance touch screen comprises four mutual capacitance touch units 1000, and the structures of the driving layer 200 and the sensor layer 300 of each mutual capacitance touch unit 1000 can use any one of the structures in the preferred embodiments 1 to 6. The combined mutual capacitance touch screen collects the capacitance distribution data of the mutual capacitance touch units 1000 respectively through the peripheral control circuit, and accurately judges the touched condition on the whole touch panel 1100 by data summarization and analysis.

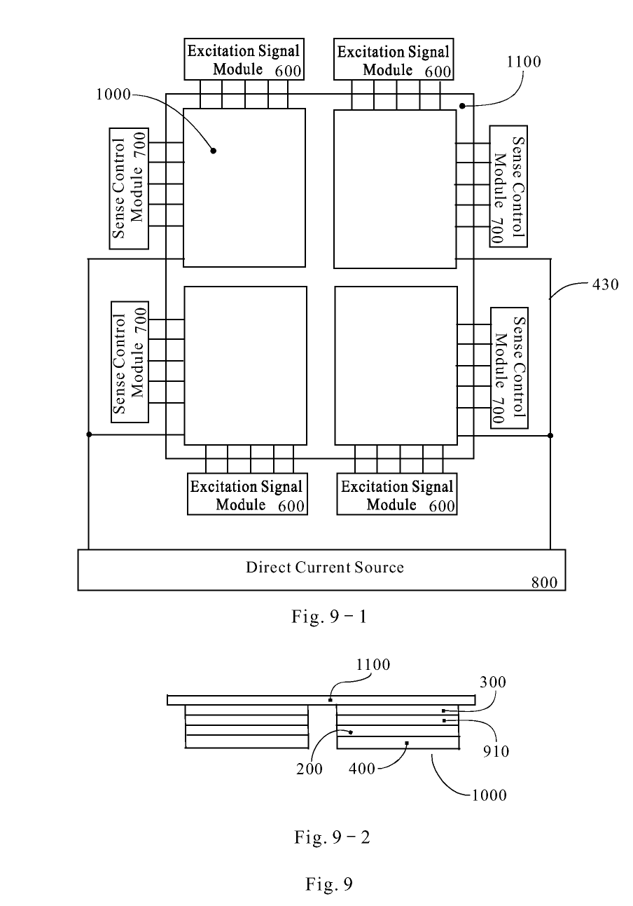

The eighth preferred embodiment is shown in FIG. 9: On the basis of the seventh preferred embodiment, the shielding layer 400 is added to each mutual capacitance touch unit 1000, wherein the shielding layer 400 is arranged above or below the lower one of the driving layer 200 and the sensor layer 300 or is embedded in the lower layer.

The shielding layer 400 comprises the plate shielding electrodes 410 made of transparent conductor materials and the shielding electrode lead-out wires 430, and the shielding electrodes 410 are just over against the areas occupied by the electrodes in the higher one of the driving layer 200 and the sensor layer 300. The shielding electrodes 410 can electrically hang and can also be connected with alternating current grounds, and the shielding electrodes 410 of the mutual capacitance touch units 1000 are electrically connected with the peripheral direct current sources 800 of the combined mutual capacitance touch screen by the shielding electrode lead-out wires 430 in the preferred embodiment.

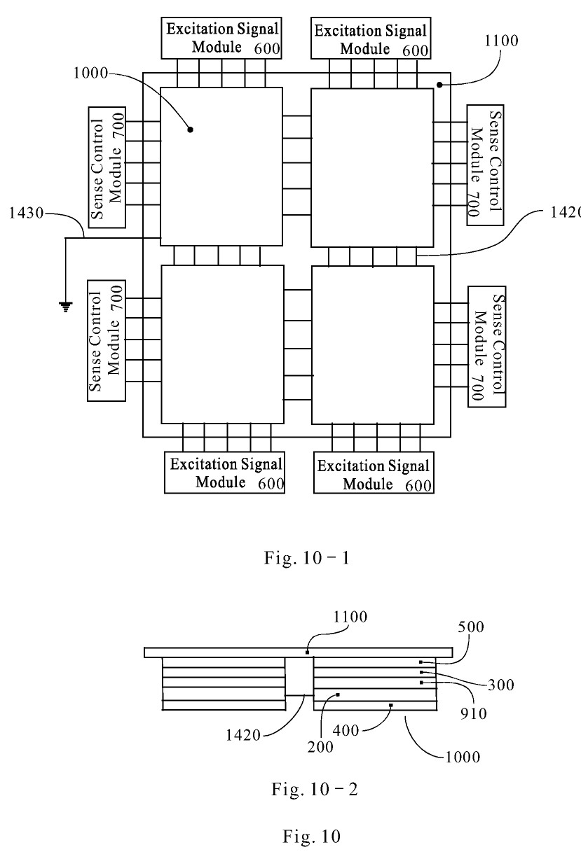

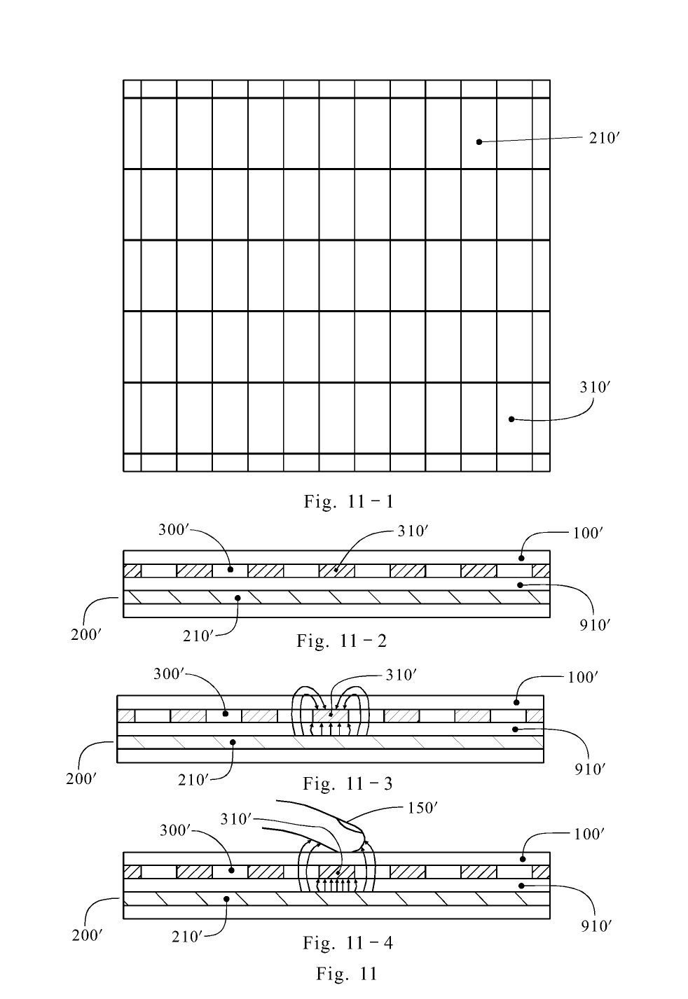

The ninth preferred embodiment is shown in FIG. 10: On the basis of the seventh preferred embodiment, the shielding layer 400 and the dummy electrode layer 500 are added to each mutual capacitance touch unit 1000. The structure of the shielding layer 400 is the same as that of the eighth preferred embodiment, and the dummy electrode layer 300 is arranged above or below the higher one of the driving layer 200 or the sensor layer 300 or embedded in the higher layer. The dummy electrode layer 500 comprises the plate dummy electrodes 510 made of transparent conductor materials, and the dummy electrodes 510 are just over against the areas occupied by the electrodes in the lower one of the driving layer 200 or the sensor layer 300.

In addition, as shown in FIG. 10, the ninth preferred embodiment different from the eighth preferred embodiment also comprises shielding layer connecting wires 1420 made of transparent conductor materials and shielding layer lead-out wires 1430; the shielding layers 400 of the mutual capacitance touch units 1000 are electrically connected together by the shielding layer connecting wires 1420 and are earthed by the shielding layer lead-out wires 1430; and certainly, the shielding electrodes can electrically hang or can be electrically connected with the peripheral direct current sources of the combined mutual capacitance touch screen.

The structures of the driving layer 200, the sensor layer 300, the shielding layer 400 and the dummy electrode layer 500 in the preferred embodiments 7 to 9 can refer to the any one of the structures of the preferred embodiments 1 to 6 or any structure conforming to the technical proposal of the present invention.

The transparent conductive materials are general materials in the prior art, which comprise Indium Tin Oxide (short for ITO) and Antimony Tin Oxide (short for ATO).

1. A mutual capacitance touch screen comprises a touch plane made of transparent insulating media, a driving layer and a sensor layer which are covered with the touch plane, and a capacitance medium plane which is made of transparent insulating media and is held between the driving layer and the sensor layer; The mutual capacitance touch screen is characterized in that:
The driving layer comprises plate driving electrodes which are made of transparent conductive materials and distributed at intervals in the same plane; the sensor layer comprises plate sense electrodes which are made of transparent conductive materials and distributed at intervals in the same plane; and the places where the sense electrodes are distributed in the sensor layer are just over against the intervals between the driving electrodes in the driving layer so that the driving electrodes and the sense electrodes together fill the touch area of the touch plane;
The driving electrodes are electrically connected with peripheral excitation signal modules of the touch screen, and the sense electrodes are electrically connected with peripheral sense control modules of the touch screen.

2. The mutual capacitance touch screen according to claim 1 is characterized in that:
The touch screen also comprises a shielding layer which is arranged above or below the lower one of the driving layer and the sensor layer or is embedded in the lower layer;
The shielding layer comprises plate shielding electrodes made of transparent conductive materials and shielding electrode lead-out wires, wherein the shielding electrodes are just over against the areas occupied by the electrodes in the higher one of the driving layer and the sensor layer;
The shielding electrodes electrically hang; or by the shielding electrode lead-out wires, all the shielding electrodes are earthed or are electrically connected with peripheral direct current sources of the touch screen.

3. The mutual capacitance touch screen according to claim 1 is characterized in that:
The touch screen also comprises a dummy electrode layer which is arranged above or below the higher one of the driving layer and the sensor layer or is embedded in the higher layer;
The dummy electrode layer comprises plate dummy electrodes made of transparent conductive materials, wherein the dummy electrodes are just over against the areas occupied by the electrodes in the lower one of the driving layer and the sensor layer.

4. The mutual capacitance touch screen according to claim 1 is characterized in that:
The touch screen also comprises driving electrode connecting wires, sense electrode connection lines, driving electrode lead-out wires and sense electrode lead-out wires, wherein the driving electrode connecting wires and the sense electrode connecting wires are made of transparent conductive materials;
The driving electrodes are grouped and connected in series by the driving electrode connecting wires, and the position relationships between the driving electrode connecting wires in the driving layer comprise collineation and parallelism; the sense electrodes are grouped and connected in series by the sense electrode connecting wires, and the position relationships between the sense electrode connecting wires in the sensor layer comprise collineation and parallelism; and the driving electrode connecting wires are perpendicular to the sense electrode connecting wires;
The driving electrode groups are electrically connected with the peripheral excitation signal modules of the touch screen by the driving electrode lead-out wires, and the sense electrode groups are electrically connected with the peripheral sense control modules of the touch screen by the sense electrode lead-out wires.

5. The mutual capacitance touch screen according to claim 1 is characterized in that:
Each driving electrode is a rectangular driving electrode, and each sense electrode is a rectangular sense electrode.

6. The mutual capacitance touch screen according to claim 1 is characterized in that:
Each driving electrode is a rhombic driving electrode, and each sense electrode is a rhombic sense electrode.

7. The mutual capacitance touch screen according to claim 1 is characterized in that:
Each driving electrode is a hexagonal driving electrode, and each sense electrode is a rhombic sense electrode.

8. A combined mutual capacitance touch screen comprises a touch panel made of transparent insulating media; The combined touch screen is characterized in that:
The combined touch screen also comprises at least two mutual capacitance touch units which are covered with the touch panel and closely arranged, and the mutual capacitance touch units together fill the touch area of the touch panel;
Each mutual capacitance touch unit comprises a driving layer, a sensor layer and a capacitance medium plane which is made of transparent insulating media and is held between the driving layer and the sensor layer;
The driving layer comprises plate driving electrodes which are made of transparent conductive materials and distributed at intervals in the same plane; the sensor layer comprises plate sense electrodes made of transparent conductive materials in the same plane; and the places where the sense electrodes are distributed in the sensor layer are just over against the intervals between the driving electrodes in the driving layer so that the driving electrodes and the sense electrodes together fill the touch area of the mutual capacitance touch unit where the driving electrodes and the sense electrodes are placed;
The driving electrodes are electrically connected with peripheral excitation signal modules of the combined mutual capacitance touch screen, which are corresponding to the mutual capacitance touch unit where the driving electrodes are placed; and the sense electrodes are electrically connected with peripheral sense control modules of the combined mutual capacitance touch screen, which are corresponding to the mutual capacitance touch unit where the sense electrodes are placed.

9. The combined mutual capacitance touch screen according to claim 8 is characterized in that:
The combined mutual capacitance touch screen also comprises shielding layer connecting wires made of transparent conductive materials and shielding layer lead-out wires;
Each mutual capacitance touch unit also comprises a shielding layer which is arranged above or below the lower one of the driving layer and the sensor layer or is embedded in the lower layer;
The shielding layer comprises plate shielding electrodes made of transparent conductive materials and shielding electrode lead-out wires; the shielding electrodes are just over against the areas occupied by the electrodes in the higher one of the driving layer and the sensor layer;
The shielding electrodes electrically hang; or the shielding layers of the mutual capacitance touch units are electrically connected together by the shielding layer connecting wires and are earthed through the shielding layer lead-out wires or are electrically connected with peripheral direct current sources of the combined mutual capacitance touch screen; or by the shielding electrode lead-out wires, the shielding electrodes of the mutual capacitance touch units are earthed or are electrically connected with the peripheral direct current sources of the combined mutual capacitance touch screen.

10. The combined mutual capacitance touch screen according to claim 8 is characterized in that:
Each mutual capacitance touch unit also comprises a dummy electrode layer which is arranged above or below the higher one of the driving layer and the sensor layer or is embedded in the higher layer;
The dummy electrode layer comprises plate dummy electrodes made of transparent conductive materials, wherein the dummy electrodes are just over against the areas occupied by the electrodes in the lower one of the driving layer and the sensor layer.
